(19) United States
(12) Patent Application Publication
(10) Pub. No.: US 2008/0073251 A1
(43) Pub. Date: Mar. 27, 2008

(54) System and process for reclaiming and recycling plastic

(76) Inventors: Piyush Reshamwala, Crystal Lake, IL (US); John Japuntich, Harvard, IL (US)

Correspondence Address: RATNERPRESTIA, P O BOX 980, VALLEY FORGE, PA, 19482-0980, US

(21) Appl. No.: 11/903,990

(22) Filed: Sep. 25, 2007

Related U.S. Application Data
(60) Provisional application No. 60/846,937, filed on Sep. 25, 2006.

(51) Int. Cl. B03C 1/00

(52) U.S. Cl. 209/214

(57) ABSTRACT

A process for reclaiming and recycling plastic from discarded articles includes dividing discarded materials into a plurality of pieces by mechanical force, removing relatively non-magnetic pieces from the plurality of pieces, separating out relatively heavy pieces from the non-magnetic pieces, segregating relatively non-conductive pieces from the relatively heavy pieces, and reclaiming plastic pieces from the relatively non-conductive pieces. The plastic pieces are processed in an injection molding machine to mold plastic product. A system for reclaiming plastic from discarded materials includes a crusher for dividing the discarded materials into a plurality of pieces, a magnetic separator for removing relatively non-magnetic pieces from the plurality of pieces, an air classifier for separating out relatively heavy pieces from the non-magnetic pieces, an electrostatic separator for segregating relatively non-conductive pieces from the relatively heavy pieces, and a metal detector for separating out plastic pieces from the relatively non-conductive pieces.

### RELATED APPLICATIONS

This application claims priority under 35 U.S.C. § 119 to U.S. Provisional Application No. 60/846,937 filed Sep. 25, 2006, the contents of which are incorporated by reference herein in their entirety.

### FIELD OF THE INVENTION

The present invention is generally directed to processes for recycling material, and more particularly to a process for reclaiming and recycling plastics from discarded products containing polypropylene or polyethylene.

### BACKGROUND OF THE INVENTION

The expense of virgin plastic material is increasing due at least in part to the increase in the cost of the raw materials, such as petroleum, used to form the plastic. Plastics recycling is becoming a common practice used in the management of municipal and industrial waste where the content of the recycled plastics material is suitable for subsequent uses. In the manufacturing industry, while it would be desirable to recycle plastics such as polypropylene and polyethylene, it is often difficult to achieve the level of purity of the recycled plastic needed for the resulting product. This is especially true for products that must meet stringent performance criteria.

The expense and difficulty associated with current recycling processes often make it difficult to justify recycling from the economic perspective. Additionally, the ability to recycle plastic is sometimes exacerbated by the presence of foreign matter that should be removed but that can not be easily separated from the desired plastic.

### SUMMARY OF THE INVENTION

In view of the foregoing, a process for reclaiming and recycling plastic from discarded articles includes a series of steps for separating plastic from other materials. In a first aspect of the invention, a process for reclaiming plastic from discarded materials includes dividing the discarded materials into a plurality of pieces by mechanical force, removing relatively non-magnetic pieces from the plurality of pieces, separating out relatively heavy pieces from the non-magnetic pieces, where the relatively heavy pieces each have a weight above a threshold value, segregating relatively non-conductive pieces from the relatively heavy pieces, and reclaiming plastic pieces from the relatively non-conductive pieces.

In a second aspect of the invention, a process for recycling plastic from discarded materials includes dividing the discarded materials into a plurality of pieces by mechanical force, removing relatively non-magnetic pieces from the plurality of pieces, separating out relatively heavy pieces from the non-magnetic pieces, where the relatively heavy pieces each have a weight above a threshold value, segregating relatively non-conductive pieces from the relatively heavy pieces, reclaiming plastic pieces from the relatively non-conductive pieces, and processing the plastic portion in an injection molding machine to mold plastic product.

In a third aspect of the invention, a system for reclaiming plastic from discarded materials includes a crusher for dividing the discarded materials into a plurality of pieces, a magnetic separator downstream of the crusher for removing relatively non-magnetic pieces from the plurality of pieces, an air classifier downstream of the magnetic separator for separating out relatively heavy pieces from the non-magnetic pieces, where the relatively heavy pieces each have a weight above a threshold value, an electrostatic separator downstream of the air classifier for segregating relatively non-conductive pieces from the relatively heavy pieces, and a metal detector downstream of the electrostatic separator for separating out plastic pieces from the relatively non-conductive pieces.

### BRIEF DESCRIPTION OF THE DRAWINGS

The foregoing summary as well as the following description will be better understood when read in conjunction with the figures in which:

FIG. 1 is a block flow diagram of a process for reclaiming and recycling plastic material in accordance with the present invention;

FIG. 2 is a block flow diagram of a process for reclaiming plastic material in accordance with the present invention;

FIG. 3 is a block flow diagram of an alternate process for reclaiming plastic material in accordance with the present invention, illustrating specific steps in the process;

FIG. 4 is a block flow diagram illustrating a first refinement step employed in the process for reclaiming plastic material of FIG. 3;

FIG. 5 is a block flow diagram illustrating a second refinement step employed in the process for reclaiming plastic material of FIG. 3; and

FIG. 6 is a system for reclaiming plastic from discarded materials in accordance with the present invention.

### DETAILED DESCRIPTION OF THE INVENTION

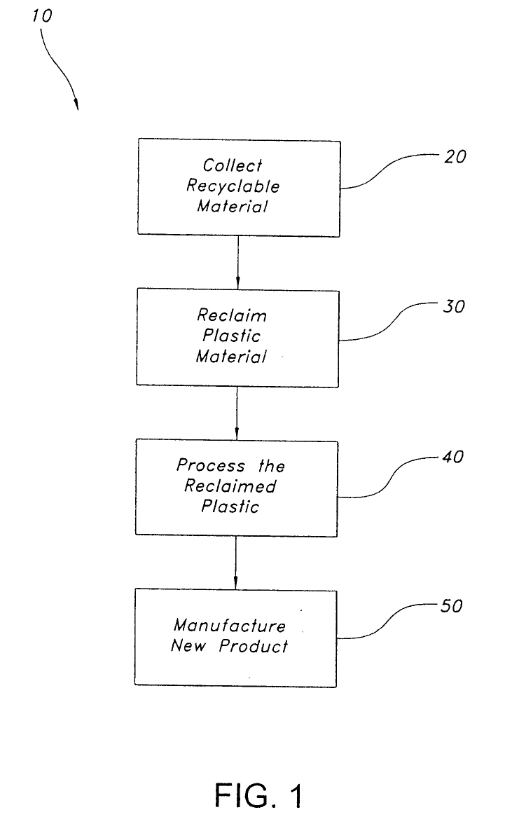

Referring to the drawing figures in general, and to FIG. 1 in particular, a process 10 for reclaiming and recycling plastic material in accordance with the present invention is illustrated in a block flow diagram. The process 10 may be used to recover plastic material found in scrap material, products that are rejected and removed from an assembly line, or other sources containing plastic. The process 10 can be used to recover a variety of plastic materials, including but not limited to polypropylene and polyethylene. In addition, the process 10 can be used to separate other materials, including metal fragments and rubber from scrap material. The separated plastic, metal and rubber fragments may be collected and either discarded or reprocessed for use in the manufacture of new products.

In general, the process 10 is divided into four major phases or steps. Initially, recyclable material containing polypropylene, polyethylene or other plastics is collected and stored in step 20. Plastic material is then reclaimed from the recyclable material in step 30. The reclaimed plastic is then processed in step 40 to prepare or condition the plastic for use in manufacturing. Finally, the processed plastic is used to manufacture new product in step 50.

The step for reclaiming plastic material from recyclable material, shown as step 30 in FIG. 1, generally includes a series of steps to isolate plastic from the discarded material. It will be understood that the reclaiming step may be used to isolate and reclaim plastic from a variety of discarded articles and materials. For purposes of this description, the reclaiming step will be described with respect to the reclaiming of plastic from syringe components formed of polypropylene, such as syringe barrels or plungers.

In the preferred embodiment, the reclaiming process is a completely dry process, meaning there is no introduction of liquids in any of the stages. Pieces are kept dry through the entire process, minimizing the need for air driers and other drying machinery that consume energy and lengthen the overall reclaiming process. At the conclusion of the reclaiming process, plastic material is isolated from the recyclable material. The recovered plastic material may then be pelletized, reshaped and combined with virgin plastic material in an appropriate amount to be incorporated into plastic molded products, including but not limited to polypropylene containers and other products.

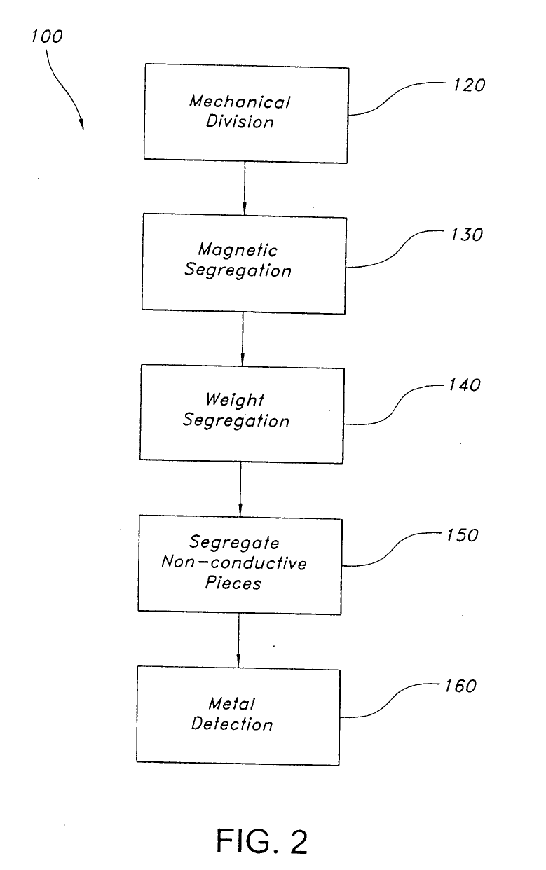

Referring to FIG. 2, a process 100 for reclaiming polypropylene from syringe components is shown in a generalized block-flow diagram. The process 100 includes a number of steps in which the recyclable material is sorted according to various properties. It will be understood that the order or arrangement of steps shown in FIG. 2 is not intended to represent the only order or arrangement that may be used. The steps of FIG. 2 may be rearranged and interchanged without departing from the scope of the invention.

Syringe components are initially moved through a mechanical division step 120, in which the components are disassembled, broken, severed, crushed or otherwise reduced into smaller-sized pieces. The mechanical division step may be controlled to produce smaller-sized pieces below a specific size limitation. For example, components may be crushed into pieces no larger than ¾ inches by ¾ inches, if desired.

Once the pieces exit the mechanical division step 120, the pieces undergo a magnetic separation step 130. The magnetic separation step 130 generally divides the pieces into a relatively magnetic portion and a relatively non-magnetic portion. The relatively non-magnetic portion may pass through the magnetic separation equipment in a single pass, or cycle through the magnetic separation equipment multiple times, depending on the nature and contents of the recyclable material.

The non-magnetic pieces are passed through a weight segregation step 140 to separate fines from the non-magnetic pieces. In particular, non-magnetic pieces are divided according to their relative weight. Non-magnetic pieces having a weight below a certain threshold limit are separated from those non-magnetic pieces having a weight above the threshold limit. The threshold weight limit may be pre-established to remove dusts and light contaminant particles from the non-magnetic pieces.

Once the heavier pieces are isolated, the heavier pieces are passed into a step 150 for isolating any remaining non-conductive material. The non-conductive material is then passed through a final metal detection step 160 to remove any remaining metallic pieces in the non-conductive portion.

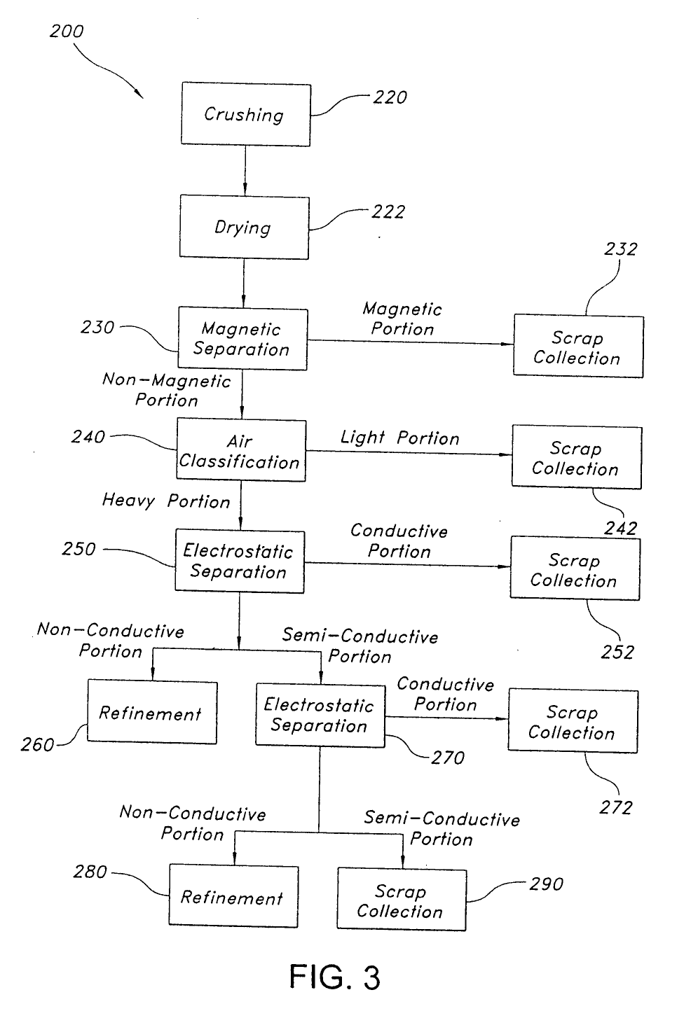

FIG. 3 provides a more detailed diagram of a plastic reclaiming process 200 in accordance with the present invention. Syringe components are initially passed through a crushing step 220. The crushing step 220 breaks down the syringe components into small pieces, which may include shards of plastic, shards of metal, pieces of rubber, dusts, and fine particles. In the preferred embodiment, crushed pieces proceed through a series of steps in a continuous process. In many instances, however, it may be more feasible to run the crushing step as a batch process that is separate from the rest of the process 200. For example, in a manufacturing facility, it may be more practical to take the rejected syringes and send them to a crushing area where material is crushed and stockpiled. When a sufficient amount of crushed material is collected, the crushed material is sent in bulk to subsequent steps in the reclaiming process.

As noted above, the reclaiming process 200 is preferably a completely dry process. In some cases, however, there may be moisture present in the crushed material. For example, crushed material that enters the system may have been stored outdoors in unsheltered areas, allowing the material to accumulate water from rain, natural condensation, or other elements. In such cases, the crushed pieces may contain a significant amount of water that can interfere with one or more steps in the reclaiming process 200. Therefore, the process 200 may optionally include one or more drying steps to reduce the potential for pieces sticking to equipment or to one another during the reclaiming process. In FIG. 3, a drying step 222 optionally follows the crushing step 222. The drying step 222 includes passing the pieces through one or more drying furnaces to rapidly remove moisture from the crushed pieces.

Once the crushed pieces have been dried, the pieces are passed through a magnetic separation step 230, which divides the pieces into a relatively magnetic portion and relatively non-magnetic portion. The relatively magnetic portion, which will typically include larger metal fragments, is collected as scrap material in step 232. Depending on its composition, the scrap material may be cycled back through the magnetic separation step 230, sent to other recycling processes, or sent to a disposal area. As used herein, any reference to “scrap collection” is intended to refer generally to the collection of residual materials for some subsequent purpose, including but not limited to subsequent sorting, processing or disposal. The relatively non-magnetic portion is passed through an air classification step 240, which segregates the relatively non-magnetic pieces according to weight. Lighter pieces, including finer particles and dusts, are removed and sent to a disposal step 242. For example, fine particles and dusts may be collected in bag houses for disposal. The heavy portion is passed to an electrostatic separation step 250.

In the electrostatic separation step 250, the heavy portion is ionized in a high voltage electrostatic field. Conductive materials and non-conductive materials are separated on the principle that conductive materials will lose their charge more rapidly than non-conductive materials. Polypropylene has a very low conductivity relative to metals and will behave differently than metals during electrostatic separation. A number of components may be used in the electrostatic separation step. For example, an electrostatic drum separator may be used. In the case of an electrostatic drum separator, polypropylene material will remain charged longer than other materials and therefore adhere longer to the rotating drum, while metals will lose charge earlier and fall off the rotating drum. Material that enters the electrostatic separation step 250 is preferably dry material and free of dust. Therefore, process 200 may include one or more drying steps or cyclone separation steps prior to the electrostatic separation step 250.

The electrostatic separation step 250 separates the heavy portion into a conductive portion, a moderately conductive (“semi-conductive”) portion and a non-conductive portion. The conductive portion, which includes larger metals, is collected as scrap in step 252. The non-conductive and semi-conductive material exit the electrostatic separation step 250 and enter separate refinement steps, as described below.

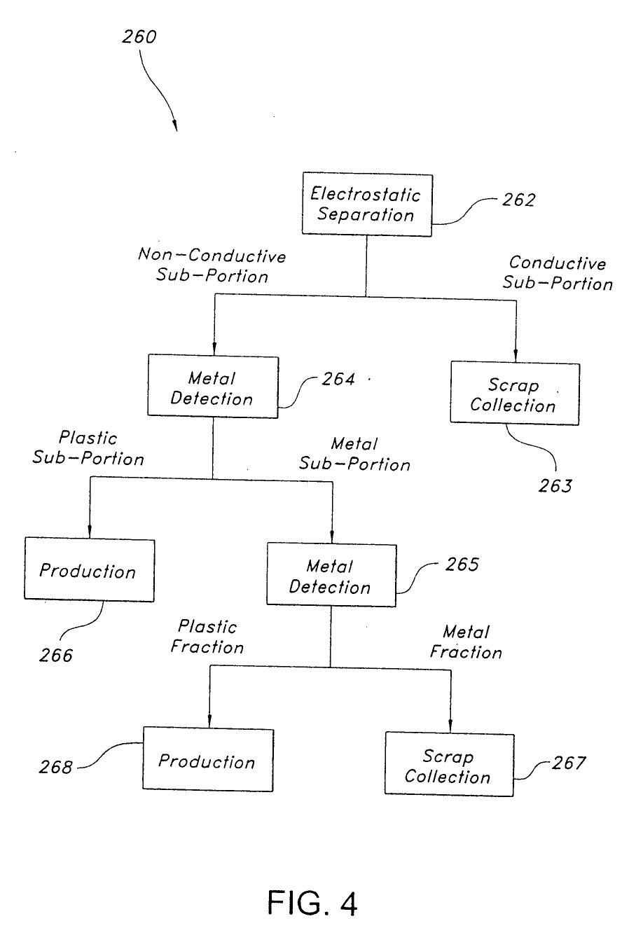

The non-conductive material enters a refinement step 260 to divide the material into a predominantly plastic fraction and a predominantly metal fraction. Referring now to FIG. 4, refinement step 260 includes an electrostatic process step 262 which separates the non-conductive material into a relatively conductive sub-portion and a relatively non-conductive sub-portion. The relatively conductive sub-portion is collected as scrap in step 263. The relatively non-conductive sub-portion is further refined in a metal detection step 264. The metal detection step 264 detects remaining metallic material and divides the relatively non-conductive sub-portion into a plastic sub-portion and a metal sub-portion. The plastic sub-portion is collected for use in production in step 266. The metal sub-portion is passed through a second metal detection step 265. The metal detection step 265 further divides the material into a predominantly plastic fraction and a predominantly metal fraction. The plastic fraction is collected for use in production in step 268. The metal fraction is collected as scrap for disposal in step 267.

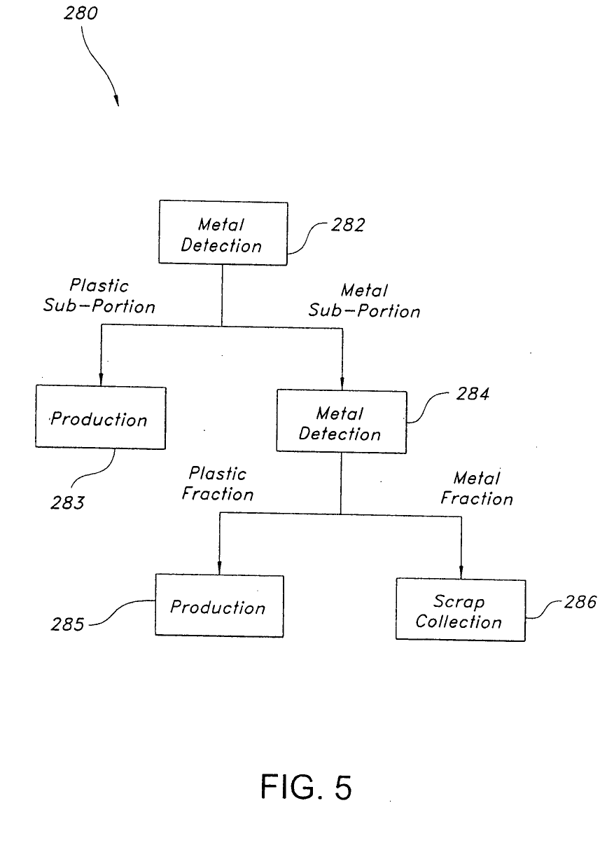

Referring back to FIG. 3, the semi-conductive material from electrostatic step 250 enters another electrostatic separation step 270. Electrostatic separation step 270 further segregates the material into a conductive sub-portion, a semi-conductive sub-portion and a non-conductive sub-portion. The conductive portion is collected as scrap material in step 272. The semi-conductive sub-portion is collected as scrap in step 290. The non-conductive portion enters a refinement step 280. Referring to FIG. 5, the non-conductive portion enters a metal detection step 282, which divides the material into a plastic sub-portion and a metal sub-portion. The plastic sub-portion is collected in step 283 for use in production. The metal sub-portion is sent to another metal detection step 284. Metal detection step 284 divides the metal sub-portion into a predominantly plastic fraction and a predominantly metal fraction. The metal fraction is collected in step 285 for use in production, and the metal fraction is collected as scrap in step 286.

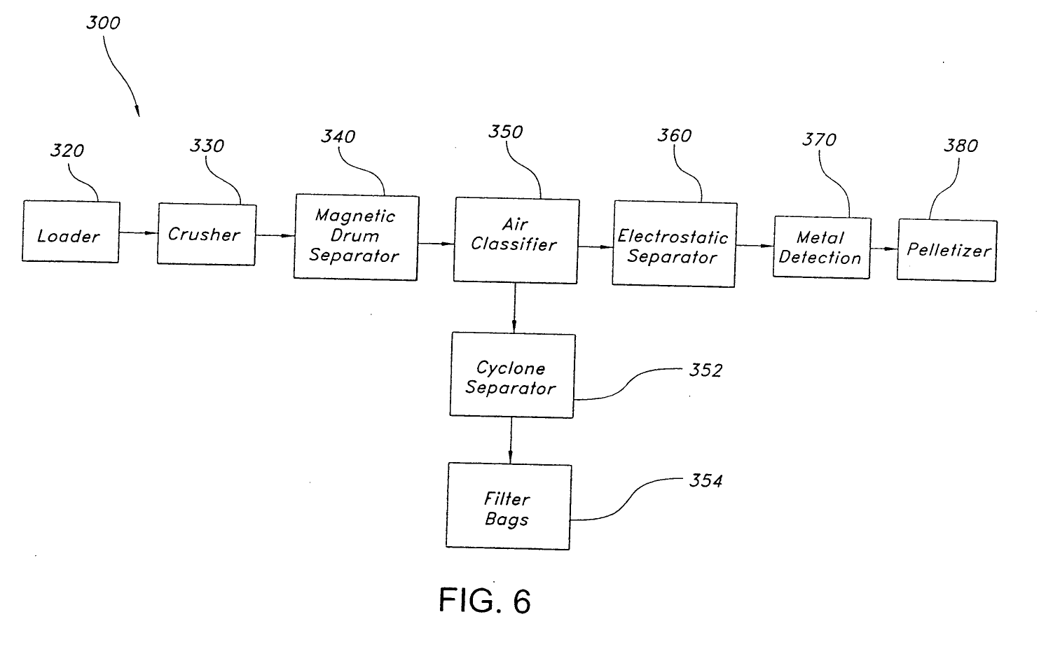

Referring now to FIG. 6, one possible configuration of a system 300 for reclaiming plastic material is illustrated. It will be understood that a number of components can be used to perform the described steps, and that the components described in the following paragraphs represent just one possible system. The system includes a loader 320 that receives recyclable material and transports the material, preferably at a controlled rate, to a crusher 330. The loader 320 may include a box tipper that dumps recyclable material directly into the crusher. The crusher 330 may include a hammer mill that applies mechanical force to break up large pieces into smaller fragments.

A magnetic drum separator 340 receives fragments from the crusher 330 and separates the fragments into magnetic pieces and non-magnetic pieces. The non-magnetic pieces are sent to an air classification system 350, which separates the pieces into a relatively heavy portion and a relatively light portion, based on a threshold weight. The lighter particles, which include finer pieces and dust, are drawn into a cyclone separator 352. The cyclone separator discharges fines into filter bags 354 for disposal.

The heavier portion of the non-magnetic pieces are sent to an electrostatic separator 360. In the electrostatic separator 360, conductive material is separated from relatively non-conductive material. The non-conductive material is passed to a metal detector 370 which further separates out metallic pieces from non-metallic pieces. The non-metallic pieces, which mostly comprises recovered polypropylene, may then be processed as needed to make the polypropylene suitable for incorporation into new plastic products. In FIG. 6, the system 300 includes a pelletizer 380 to reform the polypropylene fragments so that they can be introduced into an injection molding machine. The polypropylene fragments may be pelletized in a series of steps, including steps for cutting, warming, densifying, filtering and cooling the material.

The medical sharps and waste disposal container produced according to aspects of the process described herein, while being formed from reclaimed or recycled material, maintains structural characteristics that makes it suitable as a container for disposal of medical sharps and medical waste. One such structural characteristic is puncture resistance. ASTM-F2132 provides a test procedure and performance requirement for the puncture resistance of materials used in the construction of containers for discarded medical waste, needles and other sharps. This test specification establishes (1) the average puncture force and (2) a minimum value of puncture force that container materials must withstand when following the test procedure. According to one exemplary embodiment, the medical sharps and waste disposal container of the present invention has an average puncture resistance of at least about 3.4 lbsf., at least about preferably 5.0 lbsf., wherein the minimum requirement for any single measurement should not be less than about 2.8 lbsf.

Another structural characteristic is impact strength. A test procedure that measures impact strength is ASTM-D5628, which determines the relative ranking of materials according to the energy required to crack or break flat, rigid plastic specimens under various specified conditions of impact of a free-falling dart. Another test for impact strength is to drop a filled, medical sharps and waste disposal container from a predetermined height (the height depends on the size and weight of the container) onto a hard surface. The container fails this impact strength test when the impact of the drop causes a medical sharp or other medical waste to escape from the container. For example, a filled, 2 gallon medical sharps disposal container containing about 2.0 lbs of mixed waste and sharps was dropped from a height of 36 inches. If no medical sharps or medical waste escaped from the container, either through a breach in a wall or the lid of the container, after being dropped from the predetermined height, the container is determined to have a sufficient impact strength.

Sharps and medical waste disposal containers, according to exemplary methods of the invention, are manufactured by conventional plastic fabrication processes including, but not limited to, plastic vacuum forming, thermoset injection molding, blow molding, rotational molding, thermoforming, structural foam molding, compression molding, resin transfer molding (RTM), coating, and dipping.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A process for reclaiming plastic from discarded materials, comprising the steps of:
A. dividing the discarded materials into a plurality of pieces by mechanical force;
B. removing relatively non-magnetic pieces from the plurality of pieces;
C. separating out relatively heavy pieces from the non-magnetic pieces, where the relatively heavy pieces each have a weight above a threshold value; and
D. segregating relatively non-conductive pieces from the relatively heavy pieces.

2. The process of claim 1 wherein the step of segregating relatively non-conductive pieces comprises dividing the relatively heavy pieces into a conductive portion, a semi-conductive portion and a relatively non-conductive portion.

3. The process of claim 2 comprising the step of segregating the semi-conductive portion into a conductive sub-portion, a semi-conductive sub-portion and a relatively non-conductive sub-portion.

4. The process of claim 3 comprising the step of separating out a metal sub-portion from the relatively non-conductive sub-portion.

5. The process of claim 4 comprising the step of separating out a relatively plastic fraction from the metal sub-portion.

6. The process of claim 1 comprising the step of dividing the relatively non-conductive pieces into a conductive sub-portion and a relatively non-conductive sub-portion.

7. The process of claim 6 comprising the step of removing a metal sub-portion from the relatively non-conductive sub-portion.

8. The process of claim 7 comprising the step of removing a relatively plastic fraction from the metal sub-portion.

9. The process of claim 1 wherein the step of dividing the discarded materials into a plurality of pieces by mechanical force comprises grinding the discarded materials and passing the ground materials through a screen.

10. The process of claim 1 wherein the step of removing relatively non-magnetic pieces from the plurality of pieces comprises passing the pieces through a magnetic drum separator.

11. The process of claim 1 wherein the step of separating out relatively heavy pieces from the non-magnetic pieces comprises passing the non-magnetic pieces through an air classification system.

12. The process of claim 1 wherein the step of separating out relatively heavy pieces from the non-magnetic pieces comprises separating out relatively light pieces from the non-magnetic pieces through a cyclone separator.

13. The process of claim 1 wherein the step of segregating out relatively non-conductive pieces from the relatively heavy pieces comprises passing the heavy pieces through an electrostatic separator.

14. The process of claim 1, further comprising the step of reclaiming plastic pieces from the relatively non-conductive pieces by passing the relatively non-conductive pieces through a metal detector.

15. The process of claim 14, further comprising the step of processing the plastic pieces in an injection molding machine to mold a plastic product.

16. The process of claim 15, further comprising the step of pelletizing the plastic pieces prior to processing the plastic portion in an injection molding machine.

17. The process of claim 15 comprising the step of mixing the plastic pieces with virgin plastic material prior to processing the plastic portion in an injection molding machine.

18. A system for reclaiming plastic from discarded materials, comprising:
means for dividing the discarded materials into a plurality of pieces;
means downstream of the dividing means for removing relatively non-magnetic pieces from the plurality of pieces;
means downstream of the removing means for separating out relatively heavy pieces from the non-magnetic pieces, where the relatively heavy pieces each have a weight above a threshold value;
means downstream of the separating means for segregating relatively non-conductive pieces from the relatively heavy pieces; and
means downstream of the segregating means for separating out plastic pieces from the relatively non-conductive pieces.

19. The system of claim 15 wherein said dividing means comprises a crusher.

20. The system of claim 15 wherein said removing means comprises a magnetic separator.

21. The system of claim 15 wherein said heavy piece separating means comprises an air classifier.

22. The system of claim 15 wherein said segregating means comprises an electrostatic separator.

23. The system of claim 15 wherein said plastic piece separating means comprises a metal detector.

24. A medical waste container comprising an injection-molded receptacle including a reclaimed plastic material and a virgin plastic material mixed with said reclaimed plastic material.

25. The medical waste container of claim 24, said receptacle having a puncture resistance of at least about 2.8 lbsf.
